(19) United States
(12) Patent Application Publication
(10) Pub. No.: US 2026/0004730 A1
(43) Pub. Date: Jan. 1, 2026

(54) DISPLAY DEVICE AND ELECTRONIC DEVICE INCLUDING THE SAME

(71) Applicant: SAMSUNG DISPLAY CO., LTD., YONGIN-SI (KR)

(72) Inventor: SEUNGBIN LEE, Yongin-si (KR)

(21) Appl. No.: 19/194,106

(22) Filed: Apr. 30, 2025

(30) Foreign Application Priority Data
Jul. 1, 2024 (KR) 10-2024-0086025

(51) Int. Cl. G09G 3/3233

(52) U.S. Cl. CPC G09G 3/3233; G09G 2300/043; G09G 2300/0819; G09G 2310/08

(57) ABSTRACT

A display device includes a light-emitting element including an anode and a cathode, a first transistor electrically connected between the anode and a first power line and switched by a voltage of a node, a second transistor electrically connected between the first transistor and a data line and switched by a write scan signal, and a third transistor electrically connected between the node and the anode and switched by a compensation scan signal. The third transistor includes an oxide semiconductor layer including a source area, a drain area, and a channel area disposed between the source area and the drain area, and a gate electrode disposed on the channel area. An upper surface of each of the source area, the drain area, and the channel area includes a plurality of first protrusions.

### CROSS-REFERENCE TO RELATED APPLICATIONS

This application claims priority under 35 U.S.C. § 119 to Korean Patent Application No. 10-2024-0086025, filed on Jul. 1, 2024, the disclosure of which is incorporated by reference herein in its entirety.

### TECHNICAL FIELD

Embodiments of the present disclosure described herein relate to a display device and an electronic device including the same.

### DISCUSSION OF RELATED ART

Electronic devices such as, for example, smartphones, digital cameras, laptop computers, navigation systems, and smart televisions, which provide images to users, typically include a display device that displays images.

The display device may include a plurality of pixels that display images, a scan driving circuit that applies scan signals to the pixels, a data driving part that applies data voltages to the pixels, and a light-emission driving part that applies light-emission signals to the pixels. The pixels may receive data voltages in response to the scan signals, and may display images by emitting light with a brightness corresponding to the data voltages in response to the light-emission signals.

Each of the pixels may include a plurality of transistors, and a light-emitting element that is connected to the transistors. The transistors may drive the light-emitting element, and the light-emitting element driven by the transistors may generate light used to display images.

### SUMMARY

Embodiments of the present disclosure provide a display device that may prevent a change in a threshold voltage of a transistor.

According to an embodiment, a display device includes a light-emitting element including an anode and a cathode, a first transistor electrically connected between the anode and a first power line and switched by a voltage of a node, a second transistor electrically connected between the first transistor and a data line and switched by a write scan signal, and a third transistor electrically connected between the node and the anode and switched by a compensation scan signal. The third transistor includes an oxide semiconductor layer including a source area, a drain area, and a channel area disposed between the source area and the drain area, and a gate electrode disposed on the channel area. An upper surface of each of the source area, the drain area, and the channel area includes a plurality of first protrusions.

In an embodiment, the third transistor further includes a first dummy gate electrode disposed under the channel area.

In an embodiment, an upper surface of the first dummy gate electrode includes a plurality of second protrusions.

In an embodiment, the display device further includes a dummy semiconductor layer disposed under the first dummy gate electrode.

In an embodiment, an upper surface of the dummy semiconductor layer includes a plurality of second protrusions.

In an embodiment, the display device further includes a second dummy gate electrode disposed between the dummy semiconductor layer and the first dummy gate electrode.

In an embodiment, an upper surface of the second dummy gate electrode includes a plurality of second protrusions.

In an embodiment, the display device further includes a lower metal layer disposed under the dummy semiconductor layer.

In an embodiment, the display device further includes a first insulation layer disposed between the first dummy gate electrode and the dummy semiconductor layer, and a second insulation layer disposed on the first insulation layer between the first dummy gate electrode and the dummy semiconductor layer.

In an embodiment, an upper surface of the first insulation layer includes a plurality of first dummy protrusions, and an upper surface of the second insulation layer includes a plurality of second dummy protrusions.

In an embodiment, the display device further includes an insulation layer disposed between the oxide semiconductor layer and the first dummy gate electrode.

In an embodiment, an upper surface of the insulation layer includes a plurality of dummy protrusions.

In an embodiment, the display device further includes a first insulation layer disposed between the gate electrode and the oxide semiconductor layer, and a second insulation layer disposed on the gate electrode.

In an embodiment, an upper surface of the first insulation layer includes a plurality of first dummy protrusions, and an upper surface of the second insulation layer includes a plurality of second dummy protrusions.

In an embodiment, the display device further includes a fourth transistor electrically connected between the node and an initialization line, and switched by an initialization scan line.

In an embodiment, the fourth transistor and the third transistor have a same lamination structure.

According to an embodiment, a display device includes a light-emitting element including an anode and a cathode, a first transistor electrically connected between the anode and a first power line and switched by a voltage of a node, a second transistor electrically connected between the first transistor and a data line and switched by a write scan signal, a third transistor electrically connected between the node and the anode and switched by a compensation scan signal, and a dummy semiconductor layer disposed under the third transistor. The third transistor includes an oxide semiconductor layer including a source area, a drain area, and a channel area disposed between the source area and the drain area, and a gate electrode disposed on the channel area. Each of an upper surface of the dummy semiconductor layer and an upper surface of the oxide semiconductor layer includes a plurality of protrusions.

In an embodiment, the third transistor further includes a first dummy gate electrode disposed under the channel area, and an upper surface of the first dummy gate electrode includes the plurality of protrusions.

According to an embodiment, an electronic device includes a processor, a memory having stored application programs for execution by the processor, a display device, and a user interface. The display device includes a display panel. The display panel includes a light-emitting element including an anode and a cathode, a first transistor electrically connected between the anode and a first power line and switched by a voltage of a node, a second transistor electrically connected between the first transistor and a data line and switched by a write scan signal, and a third transistor electrically connected between the node and the anode and switched by a compensation scan signal. The third transistor includes an oxide semiconductor layer including a source area, a drain area, and a channel area disposed between the source area and the drain area, and a gate electrode disposed on the channel area. An upper surface of each of the source area, the drain area, and the channel area includes a plurality of first protrusions. The user interface is configured to sense user input via touch or cursor select of an icon presented on the display panel. The processor is caused to execute one or more of the stored application programs upon receipt of the user input.

In an embodiment, the stored application programs include one or more of a camera application, an audiovisual streaming application, or a telephone application.

### BRIEF DESCRIPTION OF THE DRAWINGS

The above and other objects and features of the present disclosure will become more apparent by describing in detail embodiments thereof with reference to the accompanying drawings.

FIG. 1 is a perspective view of a display device according to an embodiment of the present disclosure.

FIG. 2 is a view illustrating a cross-section of the display device illustrated in FIG. 1 according to an embodiment of the present disclosure.

FIG. 3 is a view illustrating a cross-section of a display panel illustrated in FIG. 2 according to an embodiment of the present disclosure.

FIG. 4 is a block diagram of a display device according to an embodiment of the present disclosure.

FIG. 5 is an equivalent circuit diagram of any one of pixels illustrated in FIG. 4 according to an embodiment of the present disclosure.

FIG. 6 is a timing diagram of scan signals and light-emission signals for describing an operation of the pixel illustrated in FIG. 5.

FIG. 7 is a view illustrating cross-sections of a light-emitting element, a first transistor, a third transistor, and a sixth transistor illustrated in FIG. 5.

FIG. 8 is a view illustrating a planar configuration of the third and fourth transistors of the pixel illustrated in FIG. 5.

FIG. 9 is a cross-sectional view, taken along line I-I′ illustrated in FIG. 8.

FIG. 10 is a cross-sectional view, taken along line II-II′ illustrated in FIG. 8.

FIG. 11 is an enlarged view illustrating a first transistor illustrated in FIG. 7.

FIG. 12 is a view illustrating a cross-section of a third transistor according to a comparative example.

FIGS. 13A and 13B are views illustrating a path of light that enters into a third transistor according to embodiments of the present disclosure.

FIG. 14 is a view illustrating a cross-section of a third transistor according to an embodiment of the present closure.

FIG. 15A is a cross-sectional view of a third transistor according to an embodiment of the present disclosure.

FIG. 15B is a cross-sectional view of line II-II′ illustrated in FIG. 8 according to an embodiment of the present disclosure.

FIG. 16 is a block diagram illustrating an electronic device according to an embodiment.

### DETAILED DESCRIPTION

Embodiments of the present disclosure will be described more fully hereinafter with reference to the accompanying drawings. Like reference numerals may refer to like elements throughout the accompanying drawings.

It will be understood that the terms “first,” “second,” “third,” etc. are used herein to distinguish one element from another, and the elements are not limited by these terms. Thus, a “first” element in an embodiment may be described as a “second” element in another embodiment.

It should be understood that descriptions of features or aspects within each embodiment should typically be considered as available for other similar features or aspects in other embodiments, unless the context clearly indicates otherwise.

As used herein, the singular forms “a”, “an” and “the” are intended to include the plural forms as well, unless the context clearly indicates otherwise.

As used herein, the term “and/or” includes any and all combinations of one or more of the associated listed items. Expressions such as “at least one of,” when preceding a list of elements, modify the entire list of elements and do not modify the individual elements of the list.

Spatially relative terms, such as “beneath”, “below”, “lower”, “under”, “above”, “upper”, etc., may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below.

It will be understood that when a component is referred to as being “on”, “connected to”, “coupled to”, or “adjacent to” another component, it can be directly on, connected, coupled, or adjacent to the other component, or intervening components may be present. It will also be understood that when a component is referred to as being “between” two components, it can be the only component between the two components, or one or more intervening components may also be present. It will also be understood that when a component is referred to as “covering” another component, it can be the only component covering the other component, or one or more intervening components may also be covering the other component. Other words used to describe the relationships between components should be interpreted in a like fashion.

Herein, when two or more elements or values are described as being substantially the same as or about equal to each other, it is to be understood that the elements or values are identical to each other, the elements or values are equal to each other within a measurement error, or if measurably unequal, are close enough in value to be functionally equal to each other as would be understood by a person having ordinary skill in the art. For example, the term “about” as used herein is inclusive of the stated value and means within an acceptable range of deviation for the particular value as determined by one of ordinary skill in the art, considering the measurement in question and the error associated with measurement of the particular quantity (e.g., the limitations of the measurement system). For example, “about” may mean within one or more standard deviations as understood by one of the ordinary skill in the art, for example, within ±30%, 20%, 10% or 5% of the stated value. Further, it is to be understood that while parameters may be described herein as having “about” a certain value, according to embodiments, the parameter may be exactly the certain value or approximately the certain value within a measurement error as would be understood by a person having ordinary skill in the art. Other uses of these terms and similar terms to describe the relationships between components should be interpreted in a like fashion.

When terms such as “comprise” and/or “comprising” are used in the specification, it should be understood that they specify presence of the above-mentioned features, numbers, steps, operations, components, parts, and/or combinations thereof, and do not exclude presence or addition of one or more other numbers, steps, operations, components, parts, and/or combinations thereof.

Embodiments of the present disclosure provide a display device in which a plurality of protrusions is formed on the upper surface of a dummy semiconductor layer, a semiconductor pattern, and a dummy gate electrode. These protrusions may effectively diffuse light directed toward the upper and side surfaces of the semiconductor pattern, preventing direct light infiltration into certain areas. By diffusing the light in this manner, the configuration may stabilize the threshold voltage of transistors, mitigating changes caused by the photoelectric effect. This structural innovation may improve the reliability and performance of the display device, for example, by maintaining consistent transistor behavior under varying light conditions.

Herein, the term “protrusions” may refer to intentionally formed raised features or surface irregularities present on specific components of the display device, such as, for example, a semiconductor pattern, dummy gate electrodes, and insulation layers. These protrusions may be designed to improve the optical and electrical performance of the device by diffusely reflecting incident light and contributing to the stability of certain elements. Such protrusions may be formed during the fabrication process through techniques such as, for example, selective etching, deposition, or photolithography, and may be designed in terms of shape, size, and density to improve their functionality. Optically, the protrusions may scatter incoming light in multiple directions, reducing direct light infiltration into sensitive regions like the channel areas of transistors. This diffuse reflection may reduce the photoelectric effect, thereby preventing changes in the threshold voltage and maintaining consistent transistor behavior. Electrically, the protrusions may improve stability by protecting certain areas from excessive light exposure, which could otherwise degrade device performance. Further, the protrusions may influence the surface characteristics of subsequent layers, allowing for proper alignment and continuity across the device's structure. By addressing issues related to light infiltration and threshold voltage stability, the inclusion of these protrusions may provide improved reliability and performance under varying operational conditions.

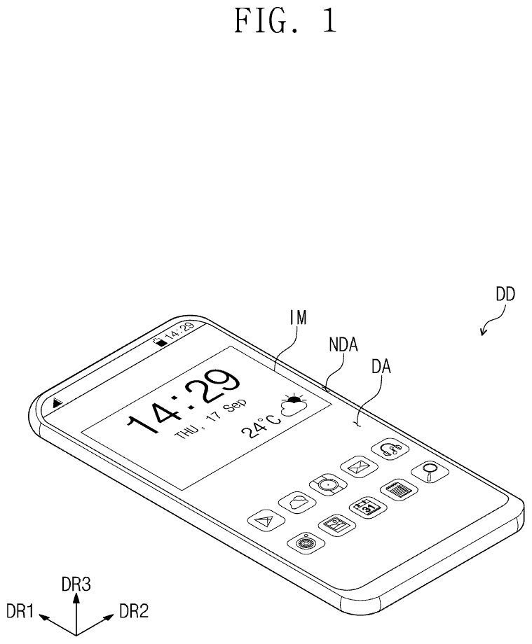

FIG. 1 is a perspective view of a display device according to an embodiment of the present disclosure.

Referring to FIG. 1, a display device DD according to an embodiment of the present disclosure may have long sides that extend in a first direction DR1, and short sides that extend in a second direction DR2 that crosses the first direction DR1. For example, the long sides extending in the first direction DR1 may be relatively longer than the short sides extending in the second direction DR2. Corners of the display device DD may have a round shape. However, the shape of the display device DD illustrated in FIG. 1 is illustrated by way of example, and the shape of the display device DD is not limited thereto.

Hereinafter, a direction that is substantially perpendicular to a plane defined by the first direction DR1 and the second direction DR2 is defined as a third direction DR3.

An image IM generated by the display device DD may be provided to the user through an upper surface of the display device DD, which is viewed from the third direction DR3. The upper surface of the display device DD may include a display area DA in which the image IM is displayed, and a non-display area NDA around the display area DA in which the image IM is not displayed. The non-display area NDA may surround the display area DA, and define a periphery of the display device DD. The non-display area NDA may correspond to a bezel area which is printed in a specific color.

In FIG. 1, the display device DD is illustrated as being a mobile phone (e.g., a smartphone). However, the display device DD is not limited thereto, and the display device DD may be used in various electronic devices. For example, the display device DD may be used in large electronic devices, such as televisions, monitors, or external billboards. Furthermore, the display device DD may be used in small and medium-sized electronic devices, such as personal computers, laptop computers, car navigation devices, game consoles, tablets, or cameras.

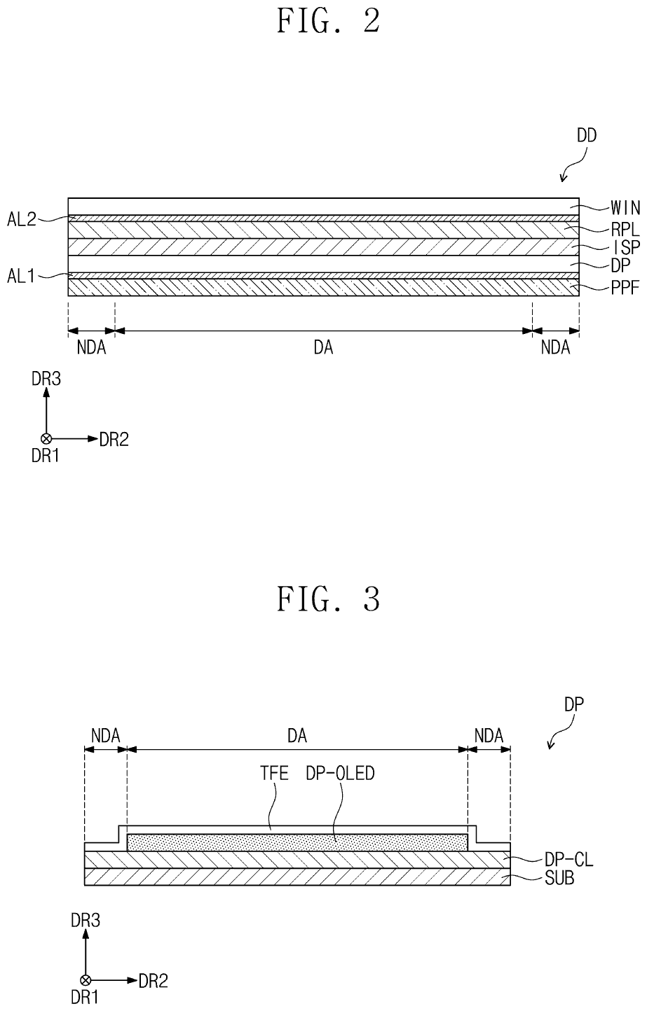

FIG. 2 is a view illustrating a cross-section of the display device illustrated in FIG. 1 according to an embodiment of the present disclosure.

By way example, FIG. 2 illustrates a cross-section of the display device DD, viewed from the first direction DR1.

Referring to FIG. 2, the display device DD may include a display panel DP, an input sensing part ISP, a reflection prevention layer RPL, a window WIN, a panel protecting film PPF, and first and second adhesion layers AL1 and AL2.

The display panel DP according to an embodiment of the present disclosure may be a light-emitting display panel. For example, the display panel DP may be an organic light-emitting display panel or an inorganic light-emitting display panel. A light-emission layer of the organic light-emitting display panel may include an organic light emitting material. A light-emission layer of the inorganic light-emitting display panel may include quantum dots, quantum rods, and the like. Hereinafter, the display panel DP will be described as an organic light-emitting display panel.

An input sensing part ISP may be disposed on the display panel DP. The input sensing part ISP may include a plurality of sensing units that sense an external input in a capacitive manner. When the display device DD is manufactured, the input sensing part ISP may be manufactured directly on the display panel DP. However, the present disclosure is not limited thereto, and the input sensing part ISP may be manufactured as a separate panel from the display panel DP, and may be attached to the display panel DP by an adhesion layer according to embodiments.

The reflection prevention layer RPL may be disposed on the input sensing part ISP. When the display device DD is manufactured, the reflection prevention layer RPL may be manufactured directly on the input sensing part ISP. However, the present disclosure is not limited thereto, and the reflection prevention layer RPL may be manufactured as a separate panel, and may be attached to the input sensing part ISP by an adhesion layer according to embodiments.

The reflection prevention layer RPL may be defined as an external light prevention layer. The reflection prevention layer RPL may reduce a reflectance of the external light that is input from the display device DD toward the display panel DP. The reflection prevention layer RPL may prevent the external light from being visually noticeable to the user.

When external light directed toward the display panel DP is reflected back to the user, it may be perceived as a mirror-like reflection. To prevent this effect, the reflection prevention layer RPL may include a plurality of color filters designed to match the color of the pixels in the display panel DP.

Color filters can block external light by matching the color of the pixels, preventing the external light from being visually noticeable to the user. However, the present disclosure is not limited to this approach. For example, according to embodiments, the reflection prevention layer RPL may include a retarder and/or a polarizer to further reduce the reflectance of external light.

The window WIN may be disposed on the reflection prevention layer RPL. The window WIN may protect the display panel DP, the input sensing part ISP, and the reflection prevention layer RPL from external scratches and impacts.

The panel protecting film PPF may be disposed under the display panel DP. The panel protecting film PPF may protect a lower portion of the display panel DP. The panel protecting film PPF may include a flexible plastic material, such as polyethylene terephthalate (PET).

The first adhesion layer AL1 may be disposed between the display panel DP and the panel protecting film PPF, and the display panel DP and the panel protecting film PPF may be combined with each other by the first adhesion layer AL1. The second adhesion layer AL2 may be disposed between the window WIN and the reflection prevention layer RPL, and the window WIN and the reflection prevention layer RPL may be combined with each other by the second adhesion layer AL2.

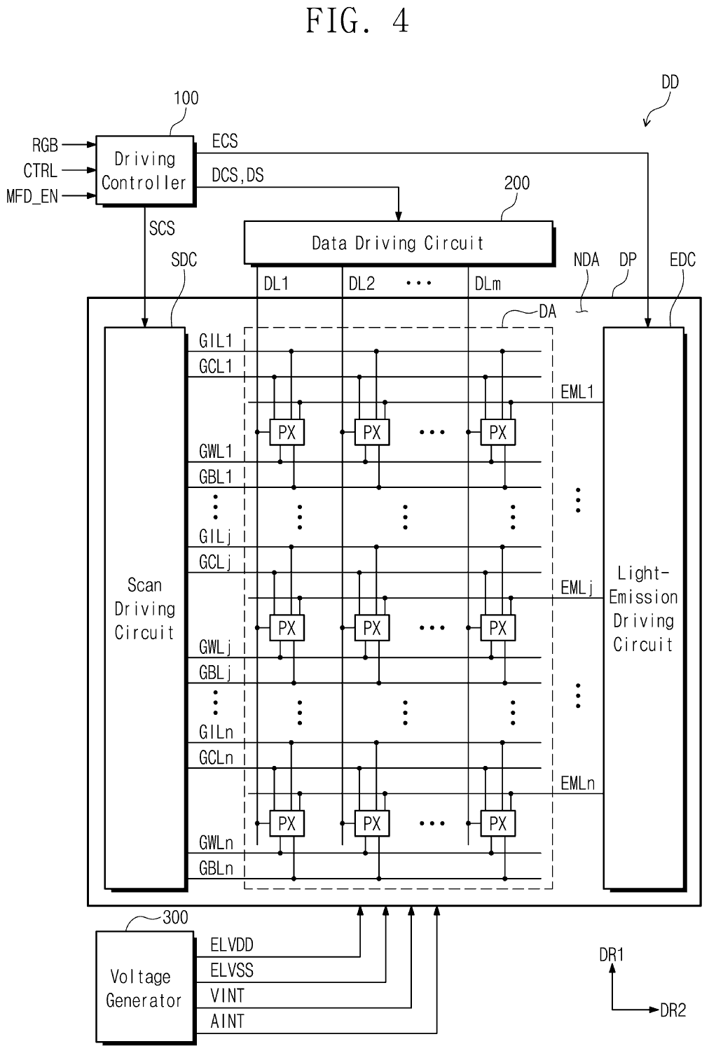

FIG. 3 is a view illustrating a cross-section of a display panel illustrated in FIG. 2 according to an embodiment of the present disclosure.

By way of example, a cross-section of the display panel DP, viewed from the first direction DR1, is illustrated in FIG. 3.

Referring to FIG. 3, the display panel DP may include a substrate SUB, a circuit element layer DP-CL disposed on the substrate SUB, a display element layer DP-OLED disposed on the circuit element layer DP-CL, and a thin-film encapsulation layer TFE disposed on the display element layer DP-OLED.

The substrate SUB may include a display area DA and a non-display area NDA around the display area DA. The substrate SUB may include a flexible plastic material, such as glass or polyimide (PI). The display element layer DP-OLED may be disposed in the display area DA.

A plurality of pixels may be disposed on the circuit element layer DP-CL and the display element layer DP-OLED. Each of the pixels may include a transistor disposed on the circuit element layer DP-CL, and a light-emitting element disposed on the display element layer DP-OLED and connected to the transistor.

The thin-film encapsulation layer TFE may be disposed on the circuit element layer DP-CL and may cover the display element layer DP-OLED. The thin-film encapsulation layer TFE may protect pixels from moisture, oxygen, and external foreign substances.

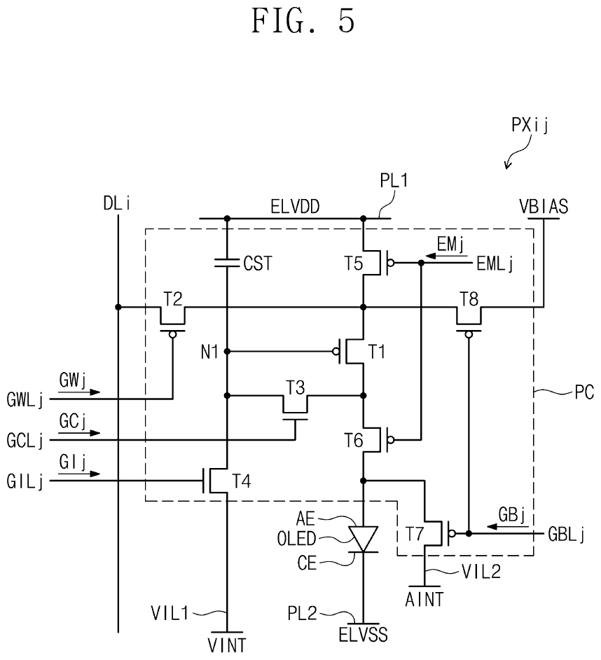

FIG. 4 is a block diagram of a display device according to an embodiment of the present disclosure.

Referring to FIG. 4, the display device DD may include a display panel DP, a driving controller 100, a data driving circuit 200, a scan driving circuit SDC, a light-emission driving circuit EDC, and a voltage generator 300. The driving controller 100 may be defined as a timing controller.

The display panel DP may include a plurality of scan lines GIL1 to GCLn, GCL1 to GCLn, GWL1 to GWLn, and GBL1 to GBLn, a plurality of light-emission lines EML1 to EMLn, a plurality of data lines DL1 to DLm, and a plurality of pixels PX, where n and m are positive integers.

An area on a plane of the display panel DP may include a display area DA and a non-display area NDA that surrounds the display area DA. The pixels PX may be disposed in the display area DA. The pixels PX may be electrically connected to the scan lines GIL1 to GCLn, GCL1 to GCLn, GWL1 to GWL1, and GBL1 to GBLn, the light-emission lines EML1 to EMLn, and the data lines DL1 to DLm, respectively.

Each of the pixels PX may be electrically connected to four corresponding scan lines and one corresponding light-emission line. For example, the pixels in the j-th row may be connected to j-th scan lines GILj, GCLj, GWLj, and GBLj, and a j-th light-emission line EMLj, where j is a positive integer.

The scan lines GIL1 to GCLn, GCL1 to GCLn, GWL1 to GWLn, and GBL1 to GBLn may include a plurality of initialization scan lines GIL1 to GILn, a plurality of compensation scan lines GCL1 to GCLn, a plurality of write scan signals GWL1 to GWLn, and a plurality of bias scan lines GBL1 to GBLn.

Each of the pixels PX may be connected to a corresponding one of the initialization scan lines GIL1 to GILn, a corresponding one of the compensation scan lines GCL1 to GCLn, a corresponding one of the write scan lines GWL1 to GWLn, and a corresponding one of the bias scan lines GBL1 to GBLn.

The scan driving circuit SDC may be disposed on a first side of the display panel DP. The scan lines GIL1 to GCLn, GCL1 to GCLn, GWL1 to GWLn, and GBL1 to GBLn may extend from the scan driving circuit SDC in the second direction DR2.

The light-emission driving circuit EDC may be disposed on a second side of the display panel DP. The light-emission lines EML1 to EMLn may extend from the light-emission driving circuit EDC in a direction opposite to the second direction DR2.

In an example illustrated in FIG. 4, the scan driving circuit SDC and the light-emission driving circuit EDC are disposed to face each other with the pixels PX being interposed therebetween, but the present disclosure is not limited thereto. For example, the scan driving circuit SDC and the light-emission driving circuit EDC may be disposed adjacent to each other on any one of the first side and the second side of the display panel DP. Furthermore, in an embodiment, the scan driving circuit SDC and the light-emission driving circuit EDC may be configured as one circuit.

The scan lines GIL1 to GCLn, GCL1 to GCLn, GWL1 to GWLn, and GBL1 to GBLn and the light-emission lines EML1 to EMLn may be spaced apart from each other in the first direction DR1. The data lines DL1 to DLm may extend from the data driving circuit 200 in a direction opposite to the first direction DR1, and may be spaced apart from each other in the second direction DR2.

The driving controller 100 may receive an image signal RGB, a control signal CTRL, and a mode signal MFD_EN. The driving controller 100 may generate an image data signal DS that is obtained by converting the data format of the image signal RGB to match the interface specification with the data driving circuit 200. The driving controller 100 may output a scan control signal SCS, a data control signal DCS, and an emission control signal ECS in response to a control signal CTRL.

The data driving circuit 200 may receive a data control signal DCS and an image data signal DS from the driving controller 100. The data driving circuit 200 may convert the image data signal DS into data signals and output them. The data signals may be defined as analog voltages corresponding to a gray level of the image data signal DS. The data signals may be applied to the pixels PX through the data lines DL1 to DLm.

The voltage generator 300 may generate voltages utilized for an operation of the display panel DP. The voltage generator 300 may generate a first driving voltage ELVDD, a second driving voltage ELVSS, a first initialization voltage VINT, and a second initialization voltage AINT. The first driving voltage ELVDD, the second driving voltage ELVSS, the first initialization voltage VINT, and the second initialization voltage AINT may be applied to the pixels PX.

The scan driving circuit SDC may receive the scan control signal SCS from the driving controller 100. The scan driving circuit SDC may output scan signals to the scan lines GIL1 to GILn, GCL1 to GCLn, GWL1 to GWLn, and GBL1 to GBLn in response to the scan control signal SCS. The scan signals may be applied to the pixels PX through the scan lines GIL1 to GCLn, GCL1 to GCLn, GWL1 to GWLn, and GBL1 to GBLn.

The light-emission driving circuit EDC may receive the light emission control signal ECS from the driving controller 100. The light-emission driving circuit EDC may output light-emission signals to the light-emission lines EML1 to EMLn in response to the light emission control signal ECS. The light-emission signals may be applied to the pixels PX through the light-emission lines EML1 to EMLn.

The driving controller 100 may determine an operation mode in response to the mode signal MFD_EN. In an embodiment, the mode signal MFD_EN may indicate whether the operation mode is a normal mode or a low frequency mode. In an embodiment, the mode signal MFD_EN may be provided from a host processor (e.g., a graphic processor or an application processor).

The driving controller 100 may drive the display panel DP at the first driving frequency when the operation mode is the normal mode. The driving controller 100 may drive the display panel DP at the second driving frequency when the operation mode is the low frequency mode.

When the operation mode is the low frequency mode, the driving controller 100 may change a clock signal that is applied to the scan driving circuit from an alternating current to a direct current. The operation will be described in further detail below.

The pixels PX may receive data voltages in response to scan signals. The pixels PX may display an image by emitting light having a luminance corresponding to data voltages in response to light-emission signals.

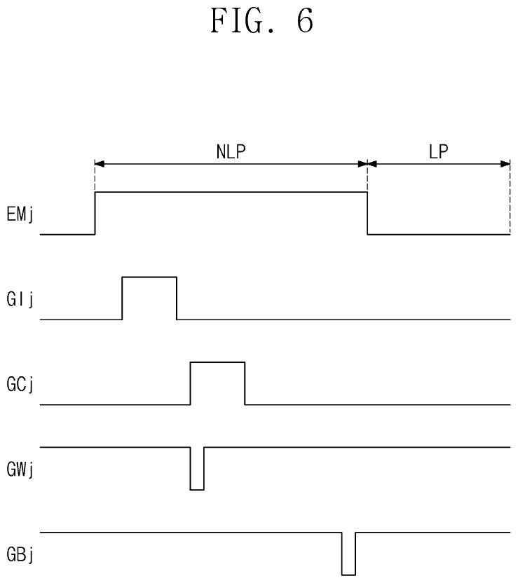

FIG. 5 is an equivalent circuit diagram of any one of the pixels PX illustrated in FIG. 4 according to an embodiment of the present disclosure.

By way of example, in FIG. 5, a first pixel PXij that is connected to an i-th data line DLi, j-th scan lines GWLj, GCLj, GILj, and GBLj, and a j-th light-emission line EMLj is illustrated, where i is a positive integer.

Referring to FIG. 4, the first pixel PXij may include a pixel circuit PC, and a light-emitting element OLED connected to the pixel circuit PC. The pixel circuit PC may drive the light-emitting element OLED. For example, the light-emitting element may be an organic light-emitting diode (OLED).

The pixel circuit PC may include a plurality of transistors T1 to T8 and a capacitor CST. The transistors T1 to T8 and the capacitor CST may control an amount of current that flows through the light-emitting element OLED. The light-emitting element OLED may generate light having a specific luminance depending on an amount of current that is provided.

The j-th write scan line GWLi may receive the j-th write scan signal GWj, and the j-th compensation scan line GCLj may receive the j-th compensation scan signal GCj. The j-th initialization scan line GILj may receive the j-th initialization scan signal GIj, and the j-th bias scan line GBLj may receive the j-th bias scan signal GBj. The j-th light-emission line EMLj may receive the j-th light-emission signal EMj.

The first pixel PXij may be connected to an i-th data line DLi, a j-th write scan line GWLi, a j-th compensation scan line GCLj, a j-th initialization scan line GILj, a j-th bias scan line GBLj, a j-th light-emission line EMLj, a first initialization line VIL1, a second initialization line VIL2, a bias line VBL, and first and second power lines PL1 and PL2.

The first initialization line VIL1 may receive the first initialization voltage VINT, and the second initialization line VIL2 may receive the second initialization voltage AINT. The bias line VBL may receive the bias voltage VBIAS. The first power line PL1 may receive the first driving voltage ELVDD, and the second power line PL2 may receive the second driving voltage ELVSS.

Each of the transistors T1 to T8 may include a source area, a drain area, and a gate electrode. Hereinafter, for convenience, in FIG. 5, any one of the source area and the drain area is defined as a first electrode, and the other is defined as a second electrode. Furthermore, the gate electrode is defined as a control electrode.

The transistors T1 to T8 may include first to eighth transistors T1 to T8. The first, second, and fifth to eighth transistors T1, T2, and T5 to T8 may be p-type metal-oxide semiconductor (PMOS) transistors. The third and fourth transistors T3 and T4 may be n-type metal-oxide semiconductor (NMOS) transistors.

The first transistor T1 may be defined as a driving transistor, and the second transistor T2 may be defined as a switching transistor. The third transistor T3 may be defined as a compensation transistor. The fourth transistor T4 and the seventh transistor T7 may be defined as initialization transistors. The fifth transistor T5 and the sixth transistor T6 may be defined as light-emission control transistors. The eighth transistor T8 may be defined as a bias transistor.

The light-emitting element OLED may be defined as an organic light-emitting element. The light-emitting element OLED may include an anode AE and a cathode CE. The anode AE may receive the first driving voltage ELVDD through the sixth, first, and fifth transistors T6, T1, and T5. The first driving voltage ELVDD may be applied to the pixel circuit PC through the first power line PL1.

The cathode CE may receive the second driving voltage ELVSS having a lower level than that of the first driving voltage ELVDD. The second driving voltage ELVSS may be applied to the pixel circuit PC through the second power line PL2.

The first transistor T1 may be disposed between the fifth transistor T5 and the sixth transistor T6, and may be connected to the fifth transistor T5 and the sixth transistor T6. The first transistor T1 may be connected to the first power line PL1 through the fifth transistor T5, and may be connected to the anode AE through the sixth transistor T6.

The first transistor T1 may include a first electrode that is connected to the first power line PL1 through the fifth transistor T5, a second electrode that is connected to the anode AE through the sixth transistor T6, and a control electrode that is connected to a first node N1.

The first electrode of the first transistor T1 may be connected to the fifth transistor T5, and the second electrode of the first transistor T1 may be connected to the sixth transistor T6. The first transistor T1 may control an amount of current that flows through the light-emitting element OLED depending on a voltage of the first node N1, which is applied to the control electrode of the first transistor T1.

The second transistor T2 may be disposed between the first transistor T1 and the i-th data line DLi, and may be connected to the first transistor T1 and the i-th data line DLi. The second transistor T2 may include a first electrode that is connected to the i-th data line DLi, a second electrode that is connected to the first electrode of the first transistor T1, and a control electrode that is connected to the j-th write scan signal GWj.

The second transistor T2 may be turned on by the j-th write scan signal GWj applied through the j-th write scan signal GWj to electrically connect the i-th data line DLi to the first electrode of the first transistor T1. The second transistor T2 may perform a switching operation of providing the data voltage VD (corresponding to the above-described data signal) that is applied through the i-th data line DLi to the first electrode of the first transistor T1.

The third transistor T3 may be connected to the second electrode of the first transistor T1 and the first node N1. The third transistor T3 may include a first electrode that is connected to the second electrode of the first transistor T1, a second electrode that is connected to the first node N1, and a control electrode that is connected to the j-th compensation scan line GCLj.

The third transistor T3 may be turned on by the j-th compensation scan signal GCj that is applied through the j-th compensation scan line GCLj to electrically connect the second electrode of the first transistor T1 and the control electrode of the first transistor T1. When the third transistor T3 is turned on, the first transistor T1 and the third transistor T3 may be connected to each other in the form of a diode.

The fourth transistor T4 may be connected to the first node N1. The fourth transistor T4 may include a first electrode that is connected to the first node N1, a second electrode that is connected to the first initialization line VIL1, and a control electrode that is connected to the j-th initialization scan line GILj. The fourth transistor T4 may be turned on by the j-th initialization scan line GILj that is applied through the j-th initialization scan line GILj to provide the first initialization voltage VINT that is applied through the first initialization line VIL1 to the first node N1.

The fifth transistor T5 may include a first electrode that is connected to the first power line PL1, a second electrode that is connected to the first electrode of the first transistor T1, and a control electrode that is connected to the j-th light-emission line EMLj.

The sixth transistor T6 may include a first electrode that is connected to the second electrode of the first transistor T1, a second electrode that is connected to the anode AE, and a control electrode that is connected to the j-th light-emission line EMLj.

The fifth transistor T5 and the sixth transistor T6 may be turned on by the j-th light-emission signal EMj that is applied through the j-th light-emission line EMLj. The first driving voltage ELVDD may be provided to the light-emitting element OLED by the turned-on fifth transistor T5 and the sixth transistor T6, so that a driving current may flow through the light-emitting element OLED. Accordingly, the light-emitting element OLED may emit light.

The seventh transistor T7 may include a first electrode that is connected to the anode AE, a second electrode that is connected to the second initialization line VIL2, and a control electrode that is connected to the j-th bias scan line GBLj. The seventh transistor T7 may be turned on by the j-th bias scan signal GBLj that is applied through the j-th bias scan line GBLj to provide the second initialization voltage AINT that is received through the second initialization line VIL2 to the anode AE of the light-emitting element OLED.

In an embodiment of the present disclosure, the seventh transistor T7 may be omitted. In an embodiment of the present disclosure, the second initialization voltage AINT may have a level different from that of the first initialization voltage VINT, but is not limited thereto, and may have the same level as that of the first initialization voltage VINT according to an embodiment.

The seventh transistor T7 may improve a black expression ability of the first pixel PXij. When the seventh transistor T7 is turned on, a parasitic capacitance of the light-emitting element OLED may be discharged. Accordingly, when the black luminance is implemented, the light-emitting element OLED does not emit light due to the leakage current of the first transistor T1, and thus, the black expression ability may be improved.

The capacitor CST may include a first electrode that is connected to the first power line PL1 and a second electrode that is connected to the first node N1. When the fifth transistor T5 and the sixth transistor T6 are turned on, an amount of current that flows through the first transistor T1 may be determined depending on a voltage that is stored in the capacitor CST.

The eighth transistor T8 may include a first electrode that is connected to the bias line VBL, a second electrode that is connected to the first electrode of the first transistor T1, and a control electrode that is connected to the j-th bias scan line GBLj.

The eighth transistor T8 may be turned on by the j-th bias scan signal GBj, and may provide a bias voltage VBIAS to the first electrode of the first transistor T1.

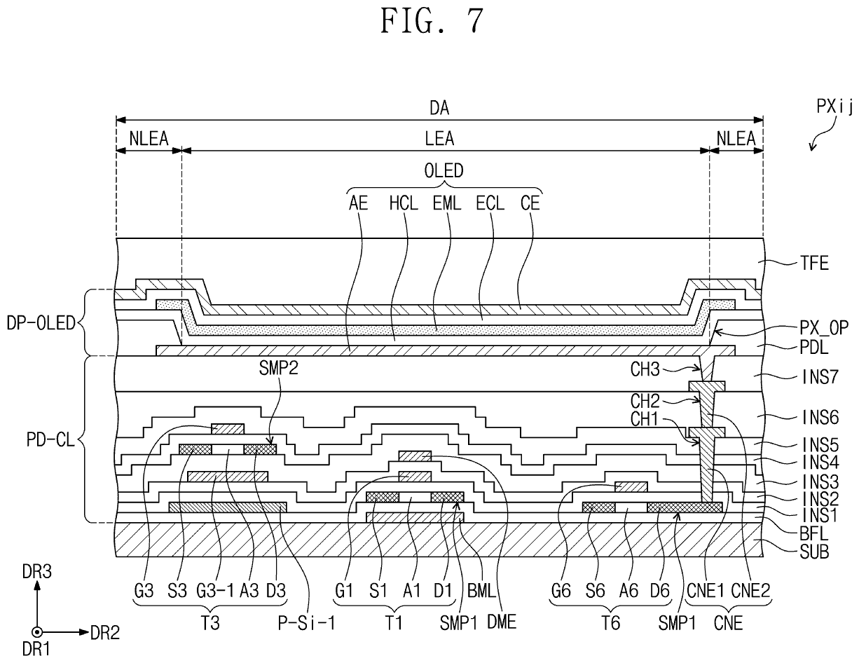

FIG. 6 is a timing diagram of scan signals and light-emission signals for describing an operation of the pixel PXij illustrated in FIG. 5.

Referring to FIGS. 5 and 6, the j-th light-emission signal EMj may have a high level during a non-light-emission period NLP and a low level during a light-emission period LP.

Enable sections of the j-th write scan signal GWj and the j-th bias scan signal GBj may be defined as low levels of the j-th write scan signal GWj and the j-th bias scan signal GBj, respectively.

The enable sections of the j-th compensation scan signal GCj and the j-th initialization scan signal GIj may be defined as high levels of the j-th compensation scan signal GCj and the j-th initialization scan signal GIj, respectively.

After the j-th initialization scan signal GIj is enabled, the j-th compensation scan signal GCj and the j-th write scan signal GWj may be enabled. Thereafter, the j-th bias scan signal GBj may be enabled.

During the non-light-emission period NLP, the j-th initialization scan signal GIj, the j-th compensation scan signal GCj, the j-th write scan signal GWj, and the j-th bias scan signal GBj that are enabled may be applied to the first pixel PXij.

The j-th initialization scan signal GIj may be applied to the fourth transistor T4 so that the fourth transistor T4 may be turned on. The first initialization voltage VINT may be provided to the first node N1 through the fourth transistor T4. Accordingly, the first initialization voltage VINT may be applied to the control electrode of the first transistor T1, and the first transistor T1 may be initialized by the first initialization voltage VINT. This operation may be defined as an initialization operation.

The j-th write scan signal GWj may be applied to the second transistor T2 so that the second transistor T2 may be turned on. Furthermore, the j-th compensation scan signal GCj may be applied to the third transistor T3 so that the third transistor T3 may be turned on.

The first transistor T1 and the third transistor T3 may be connected to each other in the form of a diode. For example, the first transistor T1 and the third transistor T3 may be diode-connected. In this case, a compensation voltage Vd-Vth that is decreased by a threshold voltage Vth of the first transistor T1 from the data voltage VD supplied through the data line DLi may be applied to the control electrode of the first transistor T1. The operation may be defined as a write operation (or a programming operation) and a compensation operation.

A first voltage ELVDD and a compensation voltage Vd-Vth may be applied to the first electrode and the second electrode of the capacitor CST, respectively. Charges corresponding to a voltage difference between the voltage of the first electrode of the capacitor CST and the voltage of the second electrode of the capacitor CST may be stored in the capacitor CST.

Thereafter, the j-th bias scan signal GBj may be applied to the seventh and eighth transistors T7 and T8, so that the seventh and eighth transistors T7 and T8 may be turned on. The second initialization voltage AINT may be provided to the anode AE through the seventh transistor T7 so that the anode AE may be initialized to the second initialization voltage AINT. The bias voltage VBIAS may be applied to the first electrode of the first transistor T1 through the eighth transistor T8.

Thereafter, the j-th light-emission signal EMj may be applied to the fifth transistor T5 and the sixth transistor T6 through the j-th light-emission line EMLj during the light-emission period LP, and thus, the fifth transistor T5 and the sixth transistor T6 may be turned on. In this case, a driving current Id corresponding to a voltage difference between a voltage of a control electrode of the first transistor T1 and the first voltage ELVDD may occur. The driving current Id may be provided to the light-emitting element OLED through the sixth transistor T6 so that the light-emitting element OLED may emit light.

The gate-source voltage Vgs of the first transistor T1 may be defined as Vgs=ELVDD−(Vd−Vth) by the capacitor CST during the light-emission period LP. The current and voltage relationship of the first transistor T1 may be defined as Id=(1) μCox (W/L) (Vgs−Vth)2. This equation is a current and voltage relationship of a general transistor.

When Vgs is substituted into a current and voltage relationship, the threshold voltage Vth is removed, and the driving current Id may be proportional to the square value ELVDD−Vd2 of a value obtained by subtracting the data voltage VD from the first voltage ELVDD. Accordingly, the driving current Id may be determined regardless of the threshold voltage Vth of the first transistor T1. This operation may be defined as a threshold voltage compensating operation.

The bias voltage VBIAS may be applied to the first electrode of the first transistor T1 through the eighth transistor T8 before the light-emitting element OLED emits light after the threshold voltage of the first transistor T1 is compensated. The movement of the hysteresis curve of the first transistor T1 may be suppressed by the bias voltage VBIAS. This operation may be defined as a bias operation.

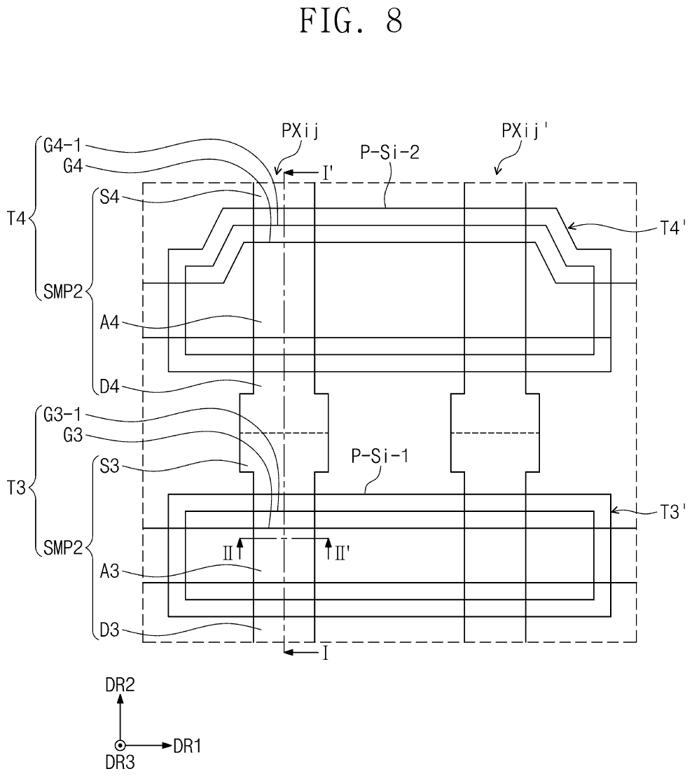

FIG. 7 is a view illustrating cross-sections of the light-emitting element OLED, the first transistor T1, the third transistor T3, and the sixth transistor T6 illustrated in FIG. 5.

Referring to FIG. 7, the light-emitting element OLED may include a first electrode AE, a second electrode CE, a hole control layer HCL, an electronic control layer ECL, and a light-emission layer EML. The first electrode AE may be the anode AE illustrated in FIG. 5, and the second electrode CE may be the cathode CE illustrated in FIG. 5.

The first, third, and sixth transistors T1, T3, and T6 and the light-emitting element OLED may be disposed on the substrate SUB. The display area DA may include a light-emission area LEA corresponding to the first pixel PXij, and a non-light-emission area NLEA adjacent to the light-emission area LEA. The light-emitting element OLED may be disposed on the light-emission area LEA.

A lower metal layer BML may be disposed on the substrate SUB. The lower metal layer BML may overlap the first transistor T1. The lower metal layer BML may block light that is directed from a lower portion thereof toward the first transistor T1. When the light is provided to the semiconductor layer of the first transistor T1, a threshold voltage of the first transistor T1 may be changed due to a photoelectric effect. Because the lower metal layer BML blocks the light that is directed toward the first transistor T1, the threshold voltage of the first transistor T1 may not be changed.

The lower metal layer BML may be connected to a first power line PL1 to receive a first voltage ELVDD. When a specific voltage is applied to the lower metal layer BML, the threshold voltage Vth of the first transistor T1 disposed on the lower metal layer BML may be maintained without being changed.

A buffer layer BFL may be disposed on the substrate SUB. The buffer layer BFL may be an inorganic layer. The buffer layer BFL may cover the lower metal layer BML. A first semiconductor pattern SMP1 of each of the first and sixth transistors T1 and T6 may be disposed on the buffer layer BFL. The first semiconductor pattern SMP1 may include polysilicon. However, the present disclosure is not limited thereto, and the first semiconductor pattern SMP1 may include amorphous silicon according to embodiments.

The first semiconductor pattern SMP1 may be doped with an N-type dopant or a P-type dopant. The first semiconductor pattern SMP1 may include a high-doped area and a low-doped area. A conductivity of the high-doped area is greater than that of the low-doped area, and may substantially serve as a source area and a drain area of the transistor TR. The low-doped area may substantially correspond to an active region (or a channel area) of the transistor.

The source area S1, the channel area A1, and the drain area D1 of the first transistor T1, and the source area S6, the channel area A6, and the drain area D6 of the sixth transistor T6, may be formed from the first semiconductor pattern SMP1. The channel area A1 may be disposed between the source area S1 and the drain area D1. The channel area A6 may be disposed between the source area S6 and the drain area D6.

A dummy semiconductor layer P-Si-1 may be disposed on the buffer layer BFL. The dummy semiconductor layer P-Si-1 may include the same material as that of the first semiconductor pattern SMP1, and may be formed substantially simultaneously with the first semiconductor pattern SMP1.

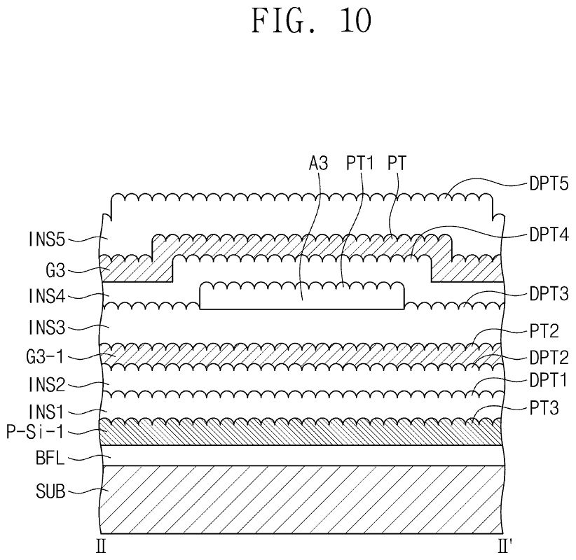

An upper surface of the dummy semiconductor layer P-Si-1 may include protrusions PT3, and layers on the dummy semiconductor layer P-Si-1 may also include protrusions. For convenience of illustration, the protrusions are omitted from FIG. 7, and will be described in further detail below with reference to FIG. 9.

A first insulation layer INS1 may be disposed on the buffer layer BFL and may cover the dummy semiconductor layer P-Si-1 and the first semiconductor pattern SMP1. Gate electrodes G1 and G6 (or control electrodes) of the first and sixth transistors T1 and T6 may be disposed on the first insulation layer INS1.

Structures of the second, fifth, and seventh transistors T2, T5, and T7 may be substantially the same as those of the first and sixth transistors T1 and T6.

A second insulation layer INS2 may be disposed on the first insulation layer INS1 and may cover the gate electrodes G1 and G6. A dummy electrode DME may be disposed on the second insulation layer INS2, and be positioned above the first and sixth transistors T1 and T6. The dummy electrode DME may form the capacitor CST together with the gate electrode G1.

The first dummy gate electrode G4-1 of the third transistor T3 may be disposed on the second insulation layer INS2.

The first dummy gate electrode G3-1 may block the light that is directed from a lower portion thereof toward the third transistor T3. For example, the first dummy gate electrode G3-1 may block light that is directed from a lower portion thereof toward the channel area A3 of the third transistor T3.

When light is provided to the semiconductor layer of the third transistor T3, the threshold voltage of the third transistor T3 may be changed due to a photoelectric effect. According to embodiments, because the first dummy gate electrode G3-1 blocks light that is directed from the lower portion toward the third transistor T3, the threshold voltage of the third transistor T3 is not changed.

A specific DC voltage may be applied to the first dummy gate electrode G3-1, and in this case, the threshold voltage Vth value of the third transistor T3 disposed on the first dummy gate electrode G3-1 may be maintained without being changed.

A third insulation layer INS3 may be disposed on the second insulation layer INS2 and may cover the first dummy gate electrode G3-1 and the dummy electrode DME.

The second semiconductor pattern SMP2 of the third transistor T3 may be disposed on the third insulation layer INS3. The second semiconductor pattern SMP2 may include an oxide semiconductor formed of a metal oxide. The oxide semiconductor may include a crystalline or amorphous oxide semiconductor.

The second semiconductor pattern SMP2 may include a plurality of areas that are classified depending on whether the metal oxide is reduced. The area in which the metal oxide is reduced (hereinafter, referred to as a reduction area) has a higher conductivity than that of the area in which the metal oxide is not reduced (hereinafter, referred to as a non-reduction area). The reduction area may substantially serve as a source area or a drain area of the transistor. The non-reduction area may substantially correspond to an active region (or channel) of the transistor.

The source area S3, the channel area A3, and the drain area D3 of the third transistor T3 may be formed from the second semiconductor patterns SMP2. The channel area A3 may be disposed between the source area S3 and the drain area D3.

The first dummy gate electrode G3-1 of the third transistor T3 may overlap portions of the second semiconductor patterns SMP2. The first dummy gate electrode G3-1 may be disposed under the channel area A3.

A fourth insulation layer INS4 may be disposed on the third insulation layer INS3 and may cover the second semiconductor pattern SMP2. A gate electrode G4 of the fourth transistor T4 may be disposed on the fourth insulation layer INS4.

A fifth insulation layer INS5 may be disposed on the fourth insulation layer INS4 and may cover the gate electrode G3. The third transistor T3 may have substantially the same structure as that of the fourth transistor T4.

The buffer layer BFL and the first to fifth insulation layers INS1 to INS5 may include inorganic layers. By way of example, the buffer layer BFL, the first insulation layer INS1, and the fourth insulation layer INS4 may include a silicon oxide layer, and the second insulation layer INS2 may include a silicon nitride layer.

The third and fifth insulation layers INS3 and INS5 may include different materials, and may include a plurality of inorganic insulation layers that are laminated on each other. For example, the third insulation layer INS3 may include a silicon nitride layer and a silicon oxide layer that are sequentially laminated, and the fifth insulation layer INS5 may include a silicon oxide layer and a silicon nitride layer that are sequentially laminated. A thickness of each of the third and fifth insulation layers INS3 and INS5 may be greater than a thickness of each of the buffer layer BFL and the first, second, and fourth insulation layers INS1, INS2, and INS4.

A connection electrode CNE may be disposed between the sixth transistor T6 and the light-emitting element OLED. The connection electrode CNE may electrically connect the sixth transistor T6 to the light-emitting element OLED. The connection electrode CNE may include a first connection electrode CNE1 and a second connection electrode CNE2 that are disposed on the first connection electrode CNE1. The first connection electrode CNE1 may be defined as a first connection pattern, and the second connection electrode CNE2 may be defined as a second connection pattern.

The first connection electrode CNE1 may be disposed on the fifth insulation layer INS5, and may be connected to the drain area D6 through first contact holes CH1 defined in the first to fifth insulation layers INS1 to INS5. The sixth insulation layer INS6 may be disposed on the fifth insulation layer INS5 and may cover the first connection electrode CNE1.

The second connection electrode CNE2 may be disposed on the sixth insulation layer INS6. The second connection electrode CNE2 may be connected to the first connection electrode CNE1 through a second contact hole CH2 defined in the sixth insulation layer INS6.

A seventh insulation layer INS7 may be disposed on the sixth insulation layer INS6 and may cover the second connection electrode CNE2. The sixth and seventh insulation layers INS6 and INS7 may include an inorganic layer or an organic layer.

A first electrode AE may be disposed on the seventh insulation layer INS7. The first electrode AE may be electrically connected to the second connection electrode CNE2 through a third contact hole CH3 defined in the seventh insulation layer INS7. A pixel definition film PDL that exposes a specific portion of the first electrode AE may be disposed on the first electrode AE and the seventh insulation layer INS7. An opening PX_OP that exposes a specific portion of the first electrode AE may be defined in the pixel definition film PDL.

The hole control layer HCL may be disposed on the first electrode AE and the pixel definition film PDL. The hole control layer HCL may be disposed in common in the light-emission area LEA and the non-light-emission area NLEA. The hole control layer HCL may include a hole transport layer and a hole injection layer.

The light-emission layer EML may be disposed on the hole control layer HCL. The light-emission layer EML may be disposed on an area corresponding to an opening PX_OP. The light-emission layer EML may include an organic material and/or an inorganic material. The light-emission layer EML may generate any one of red, green, and blue light.

The electronic control layer ECL may be disposed on the light-emission layer EML and the hole control layer HCL. The electronic control layer ECL may be disposed in common in the light-emission area LEA and the non-light-emission area NLEA. The electronic control layer ECL may include an electron transport layer and an electron injection layer. The second electrode CE may be disposed on the electronic control layer ECL. The second electrode CE may be disposed in common in the pixels PX.

The layers from the buffer layer BFL to the seventh insulation layer INS7 may collectively be referred to as a circuit element layer DP-CL. The layer on which the light-emitting element OLED is disposed may be referred to as a display element layer DP-OLED.

The thin-film encapsulation layer TFE may be disposed on the light-emitting element OLED. The thin-film encapsulation layer TFE may include an inorganic layer, an organic layer, and an inorganic layer that are sequentially laminated. The inorganic layers include an inorganic material, and may protect pixels from moisture/oxygen. The organic layer includes an organic material, and may protect the pixels PX from foreign substances, such as dust particles.

The first voltage ELVDD may be applied to the first electrode AE, and the second voltage ELVSS may be applied to the second electrode CE. Holes and electrons injected into the light-emission layer EML may combine to form excitons. The light-emitting element OLED may emit light as the excitons transition to a ground state, enabling the display of an image.

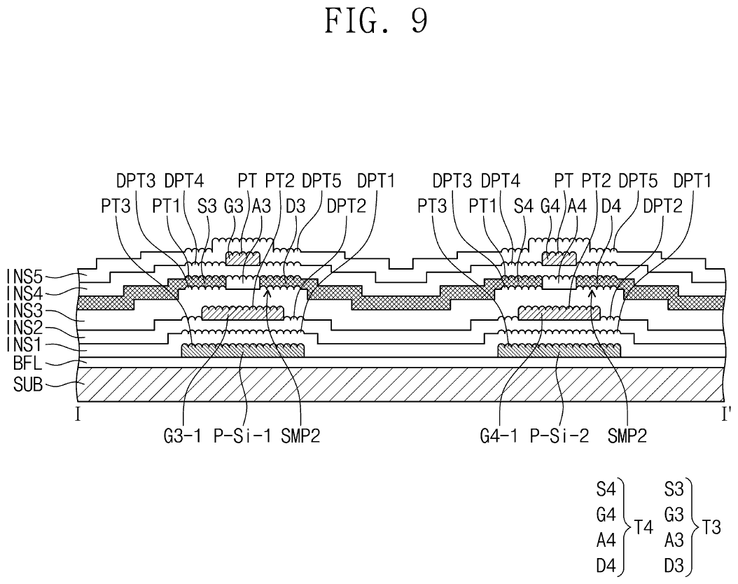

FIG. 8 is a view illustrating a planar configuration of the third and fourth transistors T3 and T4 of the pixel PXij illustrated in FIG. 5.

By way of example, two pixels PXij and PXij′ including the third and fourth transistors T3 and T4 are illustrated in FIG. 8.

Referring to FIG. 8, a pixel PXij and a pixel PXij′ may be formed symmetrically in the first direction DR1. Each of the pixel PXij and the pixel PXij′ may include a third transistor T3 and a fourth transistor T4.

The third transistor T3 of the pixel PXij and the third transistor T3′ of the pixel PXij′ are symmetrical to each other in the first direction DR1, and may have substantially the same structure. The fourth transistor T4 of the pixel PXij and the fourth transistor T4′ of the pixel PXij′ are symmetrical to each other in the first direction DR1, and may have substantially the same structure. Accordingly, for convenience of explanation, the configurations of the third and fourth transistors T3 and T4 of the pixel PXij will be described below.

The gate electrode G3, the first dummy gate electrode G3-1, and the dummy semiconductor layer P-Si-1 may extend in the first direction DR1. When viewed on a plane, the gate electrode G3, the first dummy gate electrode G3-1, and the dummy semiconductor layer P-Si-1 may overlap each other. In the first direction DR1, a width of the gate electrode G3 may be smaller than a width of the first dummy gate electrode G3-1, and the width of the first dummy gate electrode G3-1 may be smaller than a width of the dummy semiconductor layer P-Si-1. The third transistor T3 may be formed in a double gate structure including the gate electrode G3 and the first dummy gate electrode G3-1.

The second semiconductor pattern SMP2 may extend in the second direction DR2. When viewed on a plane, the second semiconductor pattern SMP2 may extend to cross the gate electrode G3, the first dummy gate electrode G3-1, and the dummy semiconductor layer P-Si-1.

The second semiconductor pattern SMP2 may include a source area S3 and a drain area D3 of the third transistor T3, and a channel area A3 disposed between the source and drain areas S3 and D3. The gate electrode G3 may overlap the channel area A3. A portion of the second semiconductor pattern SMP2, which overlaps the gate electrode G3, may be defined as a channel area A3 of the third transistor T3.

The gate electrode G4, the first dummy gate electrode G4-1, and the dummy semiconductor layer P-Si-2 may extend in the first direction DR1. When viewed on a plane, the gate electrode G4, the first dummy gate electrode G4-1, and the dummy semiconductor layer P-Si-2 may overlap each other. In the second direction DR2, a width of the gate electrode G4 may be smaller than a width of the first dummy gate electrode G4-1, and the width of the first dummy gate electrode G4-1 may be smaller than a width of the dummy semiconductor layer P-Si-2. The fourth transistor T4 may be formed in a double gate structure including the gate electrode G4 and the first dummy gate electrode G4-1

The semiconductor pattern of the third transistor T3 and the semiconductor pattern of the fourth transistor T4 may be integrally formed by the second semiconductor pattern SMP2. For example, the semiconductor pattern of the fourth transistor T4 may be formed to extend from the semiconductor pattern of the third transistor T3. When viewed on a plane, the second semiconductor pattern SMP2 may extend to cross the gate electrode G4, the first dummy gate electrode G4-1, and the dummy semiconductor layer P-Si-2.

The second semiconductor pattern SMP2 may include a source area S4 and a drain area D4 of the fourth transistor T4, and a channel area A4 disposed between the source area S4 and the drain area D4. A portion of the second semiconductor pattern SMP2, which overlaps the gate electrode G4, may be defined as the channel area A4 of the fourth transistor T4.

The source area S3 and the drain area D3 of the third transistor T3 may be connected to the first transistor T1 and the node through connection electrodes disposed on the same layer as the first connection electrode CNE1. The source area S4 and the drain area D4 of the fourth transistor T4 may be connected to the node and the first initialization line VIL1 through connection electrodes disposed on the same layer as the first connection electrode CNE1.

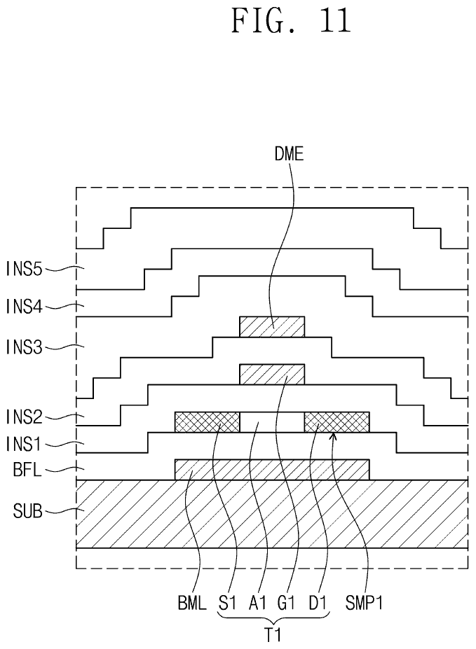

FIG. 9 is a cross-sectional view, taken along line I-I′ illustrated in FIG. 8. FIG. 10 is a cross-sectional view, taken along line II-II′ illustrated in FIG. 8.

Referring to FIGS. 9 and 10, a buffer layer BFL may be disposed on a substrate SUB. Dummy semiconductor layers P-Si-1 and P-Si-2 of the third and fourth transistors T3 and T4 may be disposed on the buffer layer BFL. A boss shape may be formed on the upper surfaces of the dummy semiconductor layers P-Si-1 and P-Si-2 of the third and fourth transistors T3 and T4. For example, the dummy semiconductor layers P-Si-1 and P-Si-2 of the third and fourth transistors T3 and T4 may be formed to include a plurality of protrusions PT3.

For example, in an embodiment, a buffer layer BFL may be disposed on the substrate SUB, providing a stable base for subsequent layers. Dummy semiconductor layers P-Si-1 and P-Si-2, corresponding to the third and fourth transistors T3 and T4, respectively, may be formed on the buffer layer BFL. The upper surfaces of the dummy semiconductor layers P-Si-1 and P-Si-2 may include raised features or protrusions, which may be collectively referred to as a boss-like structure. These protrusions PT3 may improve the structural or optical properties of the dummy semiconductor layers, such as diffusing incident light or facilitating specific functional interactions. For example, the dummy semiconductor layers P-Si-1 and P-Si-2 may be implemented with a plurality of protrusions PT3 to achieve the desired characteristics.

A first insulation layer INS1 may be disposed on the buffer layer BFL and may cover the dummy semiconductor layers P-Si-1 and P-Si-2 of the third and fourth transistors T3 and T4, and a second insulation layer INS2 may be disposed on the first insulation layer INS1. Because the upper surface of the dummy semiconductor layers P-Si-1 and P-Si-2 includes protrusions PT3, due to the protrusions PT3 of the dummy semiconductor layers P-Si-1 and P-Si-2, the upper surface of the first insulation layer INS1 may be formed to include a plurality of protrusions DPT1. Furthermore, due to the protrusions DPT1 on the upper surface of the first insulation layer INS1, the upper surface of the second insulation layer INS2 may be formed to include a plurality of protrusions DPT2. The first dummy gate electrode G3-1 of the third transistor T3 and the first dummy gate electrode G4-1 of the fourth transistor T4 may be disposed on the second insulation layer INS2. That is, the dummy semiconductor layers P-Si-1 and P-Si-2 may be disposed under the first dummy gate electrodes G3-1 and G4-1.

For example, in an embodiment, the first insulation layer INS1 may be formed on the buffer layer BFL, covering the dummy semiconductor layers P-Si-1 and P-Si-2 associated with the third and fourth transistors T3 and T4, respectively. A second insulation layer INS2 may then be formed on top of the first insulation layer INS1. Due to the protrusions PT3 present on the upper surfaces of the dummy semiconductor layers P-Si-1 and P-Si-2, the upper surface of the first insulation layer INS1 may replicate these features, resulting in a plurality of corresponding protrusions DPT1 on its upper surface. Similarly, the presence of protrusions DPT1 on the upper surface of the first insulation layer INS1 may cause the upper surface of the second insulation layer INS2 to include a corresponding plurality of protrusions DPT2.

These layered protrusions may help maintain the structural consistency of the device and may influence subsequent layer formation or functionality. Additionally, the first dummy gate electrodes G3-1 and G4-1 of the third and fourth transistors T3 and T4, respectively, may be disposed on the second insulation layer INS2. In this arrangement, the dummy semiconductor layers P-Si-1 and P-Si-2 may be positioned beneath the first dummy gate electrodes G3-1 and G4-1, enabling proper alignment and functionality within the transistor structures.

Accordingly, the first insulation layer INS1 and the second insulation layer INS2 may be disposed between the first dummy gate electrodes G3-1 and G4-1 and the dummy semiconductor layers P-Si-1 and P-Si-2. Due to the protrusions DPT2 on the upper surface of the second insulation layer INS2, the upper surfaces of the first dummy gate electrodes G3-1 and G4-1 may be formed to include a plurality of protrusions PT2.

A third insulation layer INS3 may be disposed on the second insulation layer INS2 and may cover the first dummy gate electrodes G3-1 and G4-1 of the third and fourth transistors T3 and T4. The upper surface of the third insulation layer INS3 may include protrusions DPT3 due to the protrusions DPT2 on the upper surface of the second insulation layer INS2 and the protrusions PT2 on the upper surface of the first dummy gate electrodes G3-1 and G4-1.

For example, in an embodiment, the third insulation layer INS3 may be formed on the second insulation layer INS2, encapsulating and covering the first dummy gate electrodes G3-1 and G4-1 associated with the third and fourth transistors T3 and T4, respectively. The upper surface of the third insulation layer INS3 may feature a series of protrusions DPT3. These protrusions DPT3 may result from the combined influence of the protrusions DPT2 on the upper surface of the second insulation layer INS2 and the protrusions PT2 present on the upper surfaces of the first dummy gate electrodes G3-1 and G4-1. This layering may enable the structural features of the underlying components to be replicated and preserved through subsequent layers, which may contribute to the functional or optical characteristics of the device.

The second semiconductor pattern SMP2 of the third and fourth transistors T3 and T4 may be disposed on the third insulation layer INS3. Each of the second semiconductor pattern SMP2 of the third transistors T3 and the second semiconductor pattern SMP2 of the fourth transistor T4 may be defined as an oxide semiconductor layer. The third insulation layer INS3 may be defined between the first dummy gate G3-1 and the second semiconductor pattern SMP2.

Due to the protrusions DPT3 on the upper surface of the third insulation layer INS3, the upper surface of the second semiconductor pattern SMP2 of the third and fourth transistors T3 and T4 may be formed to include a plurality of protrusions PT1. For example, the source area S3, the channel area A3, and the upper surface of the drain area D3 of the third transistor T3 may include a plurality of protrusions PT1. Furthermore, the source area S4, the channel area A4, and the upper surface of the drain area D4 of the fourth transistor T4 may include a plurality of protrusions PT1

The first dummy gate electrodes G3-1 and G4-1 may block light that is directed to the second semiconductor pattern SMP2 of the third and fourth transistors T3 and T4 under the substrate SUB. For example, the first dummy gate electrodes G3-1 and G4-1 may block light that is directed to the channel areas A3 and A4 under the substrate SUB. In this case, as described above, according to embodiments, the threshold voltages of the third and fourth transistors T3 and T4 is not changed.

A fourth insulation layer INS4 may be disposed on the second semiconductor pattern SMP2 of the third and fourth transistors T3 and T4. Due to the protrusions DPT3 on the upper surface of the third insulation layer INS3 and the protrusions PT1 on the upper surface of the second semiconductor pattern SMP2, the upper surface of the fourth insulation layer INS4 may be formed to include a plurality of protrusions DPT4.

For example, in an embodiment, the fourth insulation layer INS4 may be formed on the second semiconductor pattern SMP2 of the third and fourth transistors T3 and T4. The upper surface of the fourth insulation layer INS4 may incorporate a plurality of protrusions DPT4. These protrusions DPT4 arise from the combined influence of the protrusions DPT3 present on the upper surface of the third insulation layer INS3 and the protrusions PT1 on the upper surface of the second semiconductor pattern SMP2. This configuration may enable the structural features of the underlying layers to be replicated in the fourth insulation layer INS4, maintaining alignment and continuity across the layered structure, which may be improve the overall functionality and performance of the transistors.

The gate electrodes G3 and G4 of the third and fourth transistors T3 and T4 may be disposed on the fourth insulation layer INS4. Accordingly, a fourth insulation layer INS4 may be disposed between the gate electrodes G3 and G4 and the second semiconductor pattern SMP2. The upper surface of the gate electrodes G3 and G4 may include protrusions PT due to the protrusions DPT4 on the upper surface of the fourth insulation layer INS4.

A lamination structure of the third transistor T3 and a lamination structure of the fourth transistor T4 may be substantially the same.

A fifth insulation layer INS5 may be disposed on the gate electrodes G3 and G4 and may cover the gate electrodes G3 and G4. The upper surface of the fifth insulation layer INS5 may be formed to include a plurality of protrusions DPT5 due to the protrusions DPT4 on the upper surface of the fourth insulation layer INS4 and the protrusions PT of the gate electrodes G3 and G4.

The protrusions DPT1, DPT2, DPT3, DPT4, and DPT5 of the first to fifth insulation layers INS1, INS2, INS3, INS4, and INS5, the protrusions PT2 of the first dummy gate electrodes G3-1 and G4-1, the protrusions PT1 of the second semiconductor pattern SMP2, and the protrusions PT of the gate electrodes G3 and G4 may overlap the dummy semiconductor layers P-Si-1 and P-Si-2.

The protrusions PT1 on the upper surface of the second semiconductor pattern SMP2 may be referred to as first protrusions PT1. That is, the protrusions PT1 on the upper surfaces of the source area S3, the drain area D3, and the channel area A3 of the third transistor T3, and the protrusions PT1 on the upper surfaces of the source area S4, the drain area D4, and the channel area of the fourth transistor T4, may be referred to as the first protrusions PT1.

The protrusions PT2 on the upper surface of the first dummy gate electrode G3-1 may be referred to as second protrusions PT2, and the protrusions PT3 of the dummy semiconductor layer P-Si-1 may be referred to as third protrusions PT3.

The protrusions DPT1 on the upper surface of the first insulation layer INS1 may be referred to as first dummy protrusions DPT1, and the protrusions DPT2 on the upper surface of the second insulation layer INS2 may be referred to as second dummy protrusions DPT2.

The protrusions DPT3 on the upper surface of the third insulation layer INS3 may be referred to as third dummy protrusions DPT3, and the protrusions DPT4 on the upper surface of the fourth insulation layer INS4 may be referred to as fourth dummy protrusions DPT4. The protrusions DPT5 on the upper surface of the fifth insulation layer INS5 may be referred to as fifth dummy protrusions DPT5.

Due to the structure described above, the first dummy gate electrodes G3-1 and G4-1 of the third and fourth transistors T3 and T4 may be disposed under the semiconductor pattern.

The gate electrodes G3 and G4 of the third and fourth transistors T3 and T4 may be disposed on a layer above the gate electrode G1 of the first transistor T1 illustrated in FIG. 7. For example, the second insulation layer INS2 may be disposed on the first transistor T1, and, for example, the gate electrode G1 of the first transistor T1 may be disposed on the second insulation layer INS2. The gate electrodes G3 and G4 of the third and fourth transistors T3 and T4 may be disposed on the third insulation layer INS3 that covers the second insulation layer INS2, and thus, may be disposed on a layer above the gate electrode G1 of the first transistor T1.

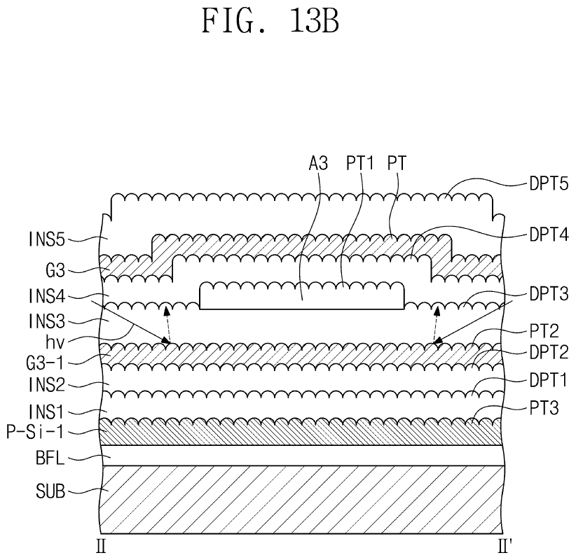

The light generated by the light-emitting element OLED may be directed toward the third and fourth transistors T3 and T4. The amount of light that enters into the channel areas A3 and A4 from the upper surface of the second semiconductor pattern SMP2 may be reduced due to the presence of the protrusions PT1 on the upper surface of the second semiconductor pattern SMP2. These protrusions PT1 on the upper surface of the second semiconductor pattern SMP2 may increase a surface roughness of the upper surface of the second semiconductor pattern SMP2, which may cause incident light to be diffusely reflected rather than directly penetrating the surface. As a result, changes in the threshold voltage Vth of the third and fourth transistors T3 and T4, which may otherwise occur due to light exposure, may be prevented. This configuration will be described in further detail below with reference to FIGS. 13A and 13B.

For example, in an embodiment, the light generated by the light-emitting element OLED may be directed toward the third and fourth transistors T3 and T4. However, the amount of light entering the channel areas A3 and A4 through the upper surface of the second semiconductor pattern SMP2 may be reduced due to the presence of protrusions PT1 on the upper surface of the second semiconductor pattern SMP2. These protrusions PT1 may increase the surface roughness of the second semiconductor pattern SMP2, causing incident light to undergo diffuse reflection rather than being directly absorbed. This diffuse reflection may reduce the amount of light entering the upper surface of the second semiconductor pattern SMP2, thereby reducing the potential for photoelectric effects that could alter the electrical characteristics of the transistors. As a result, this configuration may help prevent changes in the threshold voltage Vth of the third and fourth transistors T3 and T4 caused by light entering from above. Implementation of this configuration will be described further below with reference to FIGS. 13A and 13B.

The lamination configuration of the third and fourth transistors T3′ and T4′ of the pixel PXij′ may be substantially the same as the lamination configuration of the third and fourth transistors T3 and T4 of the pixel PXij.

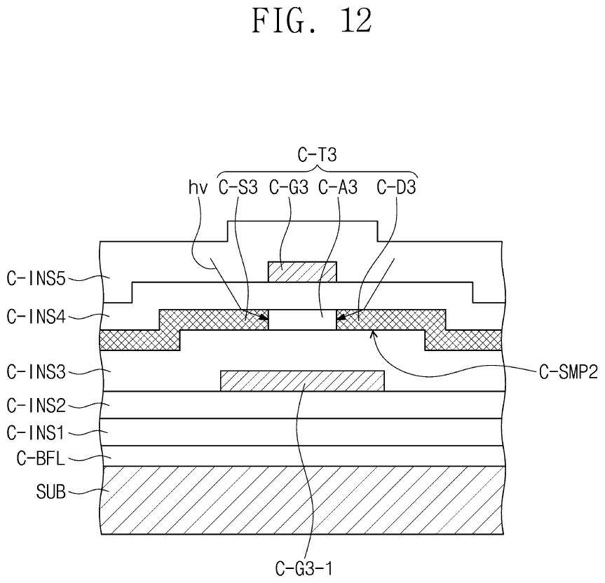

FIG. 11 is an enlarged view illustrating the first transistor T1 illustrated in FIG. 7.

Referring to FIG. 11, an upper surface of the first semiconductor pattern SMP1 of the first transistor T1 may be flat. That is, an upper surface of the dummy semiconductor layers P-Si-1 and P-Si-2 disposed under the third and fourth transistors T3 and T4 described above may have a high surface roughness while including protrusions PT3, but an upper surface of the first semiconductor pattern SMP1 may be flat.

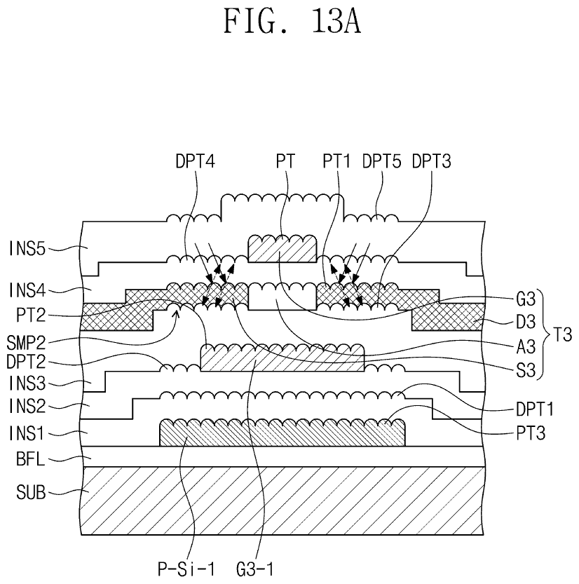

FIG. 12 is a view illustrating a cross-section of a third transistor according to a comparative example.

FIG. 12 is a view illustrating a cross-section of a third transistor C-T3 according to a comparative example, which corresponds to the cross-section of the third transistor T3 in FIG. 9.

Referring to FIG. 12, a buffer layer C-BFL may be disposed on a substrate SUB. A first insulation layer C-INS1, a second insulation layer C-INS2, a third insulation layer C-INS3, a fourth insulation layer C-INS4, and a fifth insulation layer C-INS5 may be sequentially disposed on the buffer layer C-BFL. In FIG. 12, a third transistor C-T3 includes a source area C-S3, a channel area C-A3, a drain area C-D3, and a gate electrode C-G3. Unlike the configuration illustrated in FIG. 9, in the comparative example of FIG. 12, a dummy semiconductor layer P-Si-1 including protrusions is not disposed on the buffer layer C-BFL. In this case, the upper surface of the first to fifth insulation layers C-INS1, C-INS2, C-INS3, C-INS4, and C-INS5 may have a flat surface.

Furthermore, the upper surface of the gate electrode C-G3, the second semiconductor pattern C-SMP2, the first dummy gate electrode C-G3-1, and the like may also have a flat surface.

Light hv may be incident from above onto to the third transistor C-T3. The light hv may be light hv that is generated by the light-emitting element OLED. The light hv may be refracted on the upper surfaces of the source area C-S3 and the drain area C-D3 of the semiconductor layer, and may be provided to the channel area C-A3. When the light hv is provided to the channel area C-A3, the threshold voltage of the third transistor C-T3 may be changed. Similarly, when the dummy semiconductor layer P-Si-1 is not disposed, the fourth transistor T4 may also have the same problem.

FIGS. 13A and 13B are views illustrating a path of light that enter into a third transistor according to embodiments of the present disclosure.

FIG. 13A is a view illustrating the refraction of light in the cross-section of the third transistor in FIG. 9, and FIG. 13B is a view illustrating the refraction of light in the cross-section of the third transistor in FIG. 10.

Referring to FIGS. 13A and 13B, light hv may be provided from an upper portion to the semiconductor layer. The light hv may be light hv that is generated by the light-emitting element OLED.

Light may be refracted and reflected on the upper surface of the second semiconductor pattern SMP2. The light hv may be diffusely reflected by protrusions PT1 formed on the upper surface of the source area S3 and the upper surface of the drain area D3 of the second semiconductor pattern SMP2.

Furthermore, light hv that enters into the side surface of the third transistor T3 may be diffusely reflected by a plurality of protrusions PT2 formed on the upper surface of the first dummy gate electrode G3-1. In this case, an amount of light provided to the channel area A3 of the third transistor T3 may be reduced.

Even in the fourth transistor T4 illustrated in FIG. 9, the light hv may be diffusely reflected by a plurality of protrusions PT1 formed on the upper surface of the source area S4 and the upper surface of the drain area D4. Furthermore, the light hv that enters into a side surface of the fourth transistor T4 may be diffusely reflected by the protrusions PT2 formed on the upper surface of the first dummy gate electrode G4-1.

Accordingly, an amount of light provided to the channel area A4 of the fourth transistor T4 may be reduced.

As a result, because the amount of light entering into the channel areas A3 and A4 decreases, a change in threshold voltage of the third and fourth transistors T3 and T4 may be prevented.

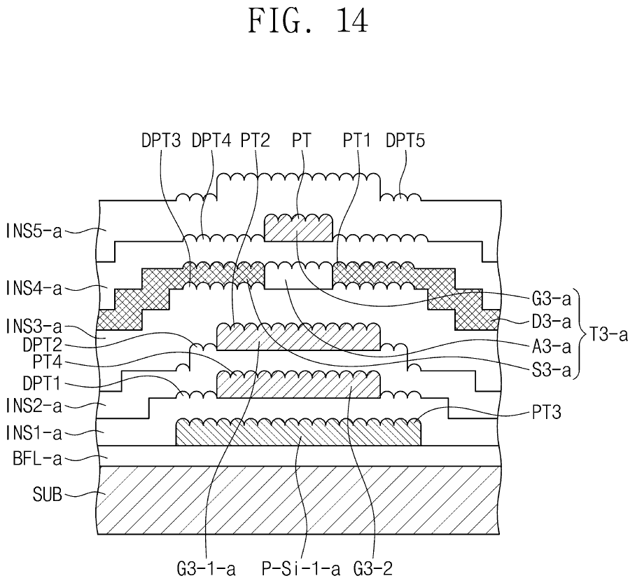

FIG. 14 is a view illustrating a cross-section of a third transistor according to an embodiment of the present closure.

By way example, FIG. 14 is illustrated as a cross-section corresponding to the cross-sectional view of the third transistor T3 illustrated in FIG. 9.

Referring to FIG. 14, in a third transistor T3-a, a gate electrode G3-a may be disposed on the source area S3-a, the channel area A3-a, and the drain area D3-a, and a first dummy gate electrode G3-1-a may be disposed under the source area S3-a, the channel area A3-a, and the drain area D3-a. The source area S3-a, the channel area A3-a, and the drain area D3-a may be defined as an oxide semiconductor layer.

A buffer layer BFL-a may be disposed on the substrate SUB. A dummy semiconductor layer P-Si-1-a may be disposed on the buffer layer BFL-a. An upper surface of the dummy semiconductor layer P-Si-1-a may be formed to include a plurality of protrusions.

The first and second insulation layers INS1-a and INS2-a may be disposed on the buffer layer BFL-a and may cover the dummy semiconductor layer P-Si-1-a. A first dummy gate electrode G3-1-a may be disposed on the second insulation layer INS2-a.

A third insulation layer INS3-a may be disposed on the second insulation layer INS2-a and may cover the first dummy gate electrode G3-a. The source area S3-a, the channel area A3-a, and the drain area D3-a may be disposed on the third insulation layer INS3-a. A fourth insulation layer INS4-a may be disposed between the source area S3-a, the channel area A3-a, the drain area D3-a, and the gate electrode G3-a. A fifth insulation layer INS5-a may be disposed on the gate electrode G3-a.

A second dummy gate electrode G3-2 may be disposed under the first dummy gate electrode G3-1-a. The second dummy gate electrode G3-2 may be disposed between the first insulation layer INS1-a and the second insulation layer INS2-a. The second dummy gate electrode G3-2 may overlap the first dummy gate electrode G3-1-a. The second dummy gate electrode G3-2 may be disposed between the dummy semiconductor layer P-Si-1-a and the first dummy gate electrode G3-1-a.

A plurality of protrusions PT4 may be formed on an upper surface of the second dummy gate electrode G3-2. The protrusions PT4 on an upper surface of the second dummy gate electrode G3-2 may be defined as fourth protrusions PT4. The entry of light from lower portions may be more efficiently blocked by the first and second dummy gate electrodes G3-1-a and G3-2.

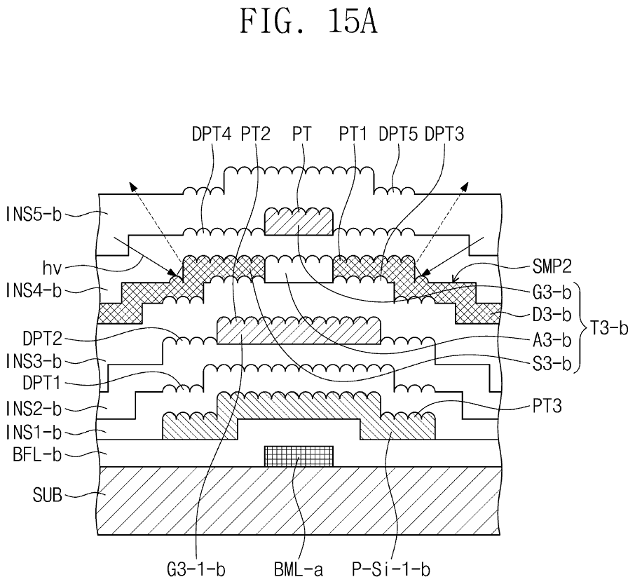

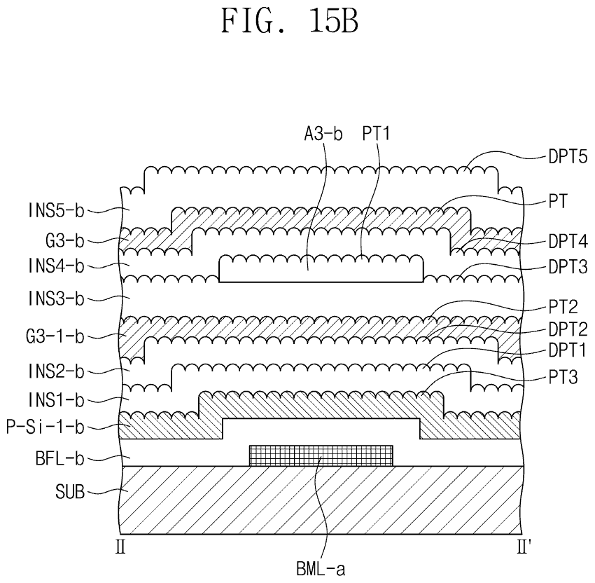

FIGS. 15A and 15B are cross-sectional views of a third transistor according to an embodiment of the present closure.

FIG. 15A may correspond to the cross-section of the third transistor T3 illustrated in FIG. 9, and FIG. 15B may correspond to the cross-section illustrated in FIG. 10.

Referring to FIGS. 15A and 15B, a lower metal layer BML-a may be disposed on a substrate SUB. The lower metal layer BML-a may be disposed under the dummy semiconductor layer P-Si-1-b.

The lower metal layer BML-a may be disposed between the substrate SUB and the buffer layer BFL-b. The dummy semiconductor layer P-Si-1-b and a third transistor T3-b may be disposed on the lower metal layer BML-a. That is, the first dummy gate electrode G3-1-b, the semiconductor layer, and a gate electrode G3-b may be disposed on the lower metal layer BML-a. The lower metal layer BML-a may overlap a channel area A3-b. The lower metal layer BML-a may have the same width in a horizontal direction as that of the channel area A3-b.

A step may be formed in each of the layers disposed on the lower metal layer BML-a by the lower metal layer BML-a. A step may be formed in the buffer layer BFL-b and first to fifth insulation layers INS1-b, INS2-b, INS3-b, INS4-b, and INS5-b. Furthermore, a step may be formed in the dummy semiconductor layer P-Si-1-b, the first dummy gate electrode G3-1-b, and the gate electrode G3-b.

In this case, the light hv that enters into the third transistor T3 may be diffusely reflected in the protrusions PT1 on the upper surface of the second semiconductor pattern SMP2, and may be reflected from the side surface of the second semiconductor pattern SMP2, on which the step is formed. Accordingly, the amount of light entering into the channel area A3-b of the third transistor T3 may be reduced.

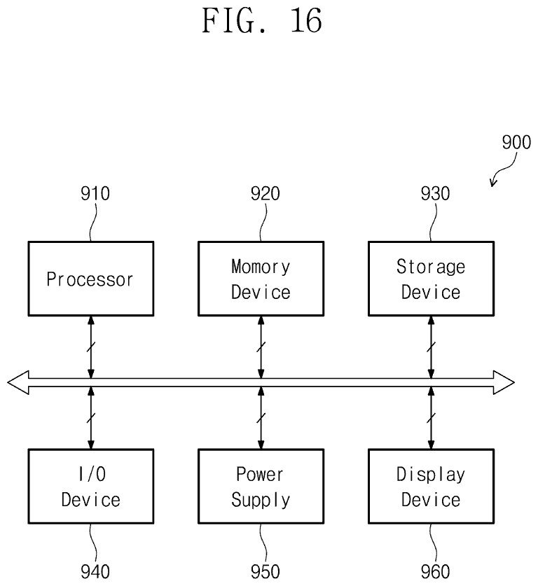

FIG. 16 is a block diagram illustrating an electronic device according to an embodiment.

Referring to FIG. 16, in an embodiment, an electronic device 900 may include a processor 910, a memory device 920, a storage device 930, an input/output (“I/O”) device 940, a power supply 950, and a display device 960. Here, the display device 960 may correspond to the display device DD described above. The electronic device 900 may further include a plurality of ports for communicating with a video card, a sound card, a memory card, a universal serial bus (“USB”) device, or the like. In an embodiment, the electronic device 900 may be implemented as a television. In an embodiment, the electronic device 900 may be implemented as a smartphone. However, embodiments are not limited thereto. For example, in an embodiment, the electronic device 900 may be implemented as a cellular phone, a video phone, a smart pad, a smart watch, a tablet personal computer (“PC”), a car navigation system, a computer monitor, a laptop, a head disposed (e.g., mounted) display (“HMD”), or the like.

The processor 910 may perform various computing functions. In an embodiment, the processor 910 may be, for example, a microprocessor, a central processing unit (“CPU”), an application processor (“AP”), or the like. The processor 910 may be coupled to other components via, for example, an address bus, a control bus, a data bus, or the like. In an embodiment, the processor 910 may be coupled to an extended bus such as a peripheral component interconnection (“PCI”) bus.

The memory device 920 may store data for operations of the electronic device 900. In an embodiment, the memory device 920 may include at least one non-volatile memory device such as an erasable programmable read-only memory (“EPROM”) device, an electrically erasable programmable read-only memory (“EEPROM”) device, a flash memory device, a phase change random access memory (“PRAM”) device, a resistance random access memory (“RRAM”) device, a nano floating gate memory (“NFGM”) device, a polymer random access memory (“PoRAM”) device, a magnetic random access memory (“MRAM”) device, a ferroelectric random access memory (“FRAM”) device, or the like, and/or at least one volatile memory device such as a dynamic random access memory (“DRAM”) device, a static random access memory (“SRAM”) device, a mobile DRAM device, or the like.

In an embodiment, the storage device 930 may include a solid state drive (“SSD”) device, a hard disk drive (“HDD”) device, a CD-ROM device, or the like. In an embodiment, the I/O device 940 may include an input device such as a keyboard, a keypad, a mouse device, a touchpad, a touch-screen, or the like, and an output device such as a printer, a speaker, or the like.

The power supply 950 may provide power for operations of the electronic device 900. The power supply 950 may provide power to the display device 960. The display device 960 may be coupled to other components via the buses or other communication links. In an embodiment, the display device 960 may be included in the I/O device 940.

According to an embodiment of the present disclosure, the surface roughness of the upper surface of the semiconductor pattern may be increased due to the plurality of protrusions formed on the upper surface of the semiconductor pattern. This increased roughness may cause light incident on the upper surface of the semiconductor pattern to undergo diffuse reflection. As a result, a change in the threshold voltage of the transistor, which may otherwise be caused by light entering from above, may be prevented.

According to an embodiment of the present disclosure, light directed toward the side surface of the semiconductor pattern may be diffusely reflected by the plurality of protrusions formed on the upper surface of the dummy gate electrode. As a result, a change in the threshold voltage of the transistor, which may otherwise be caused by light entering from the side, may be prevented.

While the present disclosure has been particularly shown and described with reference to embodiments thereof, it will be understood by those of ordinary skill in the art that various changes in form and detail may be made therein without departing from the spirit and scope of the present disclosure as defined by the following claims

What is claimed is:

1. A display device, comprising:
a light-emitting element including an anode and a cathode;
a first transistor electrically connected between the anode and a first power line, and switched by a voltage of a node;
a second transistor electrically connected between the first transistor and a data line, and switched by a write scan signal; and
a third transistor electrically connected between the node and the anode, and switched by a compensation scan signal,
wherein the third transistor includes:
an oxide semiconductor layer including a source area, a drain area, and a channel area disposed between the source area and the drain area; and
a gate electrode disposed on the channel area,
wherein an upper surface of each of the source area, the drain area, and the channel area includes a plurality of first protrusions.

2. The display device of claim 1, wherein the third transistor further includes a first dummy gate electrode disposed under the channel area.

3. The display device of claim 2, wherein an upper surface of the first dummy gate electrode includes a plurality of second protrusions.

4. The display device of claim 2, further comprising:
a dummy semiconductor layer disposed under the first dummy gate electrode.

5. The display device of claim 4, wherein an upper surface of the dummy semiconductor layer includes a plurality of second protrusions.

6. The display device of claim 4, further comprising:
a second dummy gate electrode disposed between the dummy semiconductor layer and the first dummy gate electrode.

7. The display device of claim 6, wherein an upper surface of the second dummy gate electrode includes a plurality of second protrusions.

8. The display device of claim 4, further comprising:
a lower metal layer disposed under the dummy semiconductor layer.

9. The display device of claim 4, further comprising:
a first insulation layer disposed between the first dummy gate electrode and the dummy semiconductor layer; and
a second insulation layer disposed on the first insulation layer between the first dummy gate electrode and the dummy semiconductor layer.

10. The display device of claim 9, wherein an upper surface of the first insulation layer includes a plurality of first dummy protrusions, and
wherein an upper surface of the second insulation layer includes a plurality of second dummy protrusions.

11. The display device of claim 2, further comprising:
an insulation layer disposed between the oxide semiconductor layer and the first dummy gate electrode.

12. The display device of claim 11, wherein an upper surface of the insulation layer includes a plurality of dummy protrusions.

13. The display device of claim 1, further comprising:
a first insulation layer disposed between the gate electrode and the oxide semiconductor layer; and
a second insulation layer disposed on the gate electrode.

14. The display device of claim 13, wherein an upper surface of the first insulation layer includes a plurality of first dummy protrusions, and
an upper surface of the second insulation layer includes a plurality of second dummy protrusions.

15. The display device of claim 1, further comprising:
a fourth transistor electrically connected between the node and an initialization line, and switched by an initialization scan line.

16. The display device of claim 15, wherein the fourth transistor and the third transistor have a same lamination structure.

17. A display device, comprising:
a light-emitting element including an anode and a cathode;
a first transistor electrically connected between the anode and a first power line, and switched by a voltage of a node;
a second transistor electrically connected between the first transistor and a data line, and switched by a write scan signal;
a third transistor electrically connected between the node and the anode, and switched by a compensation scan signal; and
a dummy semiconductor layer disposed under the third transistor,
wherein the third transistor includes:
an oxide semiconductor layer including a source area, a drain area, and a channel area disposed between the source area and the drain area; and
a gate electrode disposed on the channel area,
wherein each of an upper surface of the dummy semiconductor layer and an upper surface of the oxide semiconductor layer includes a plurality of protrusions.

18. The display device of claim 17, wherein the third transistor further includes a first dummy gate electrode disposed under the channel area, and an upper surface of the first dummy gate electrode includes the plurality of protrusions.

19. An electronic device, comprising:
a processor;
a memory having stored application programs for execution by the processor;
a display device, comprising:
a display panel comprising:
a light-emitting element including an anode and a cathode;
a first transistor electrically connected between the anode and a first power line, and switched by a voltage of a node;
a second transistor electrically connected between the first transistor and a data line, and switched by a write scan signal; and
a third transistor electrically connected between the node and the anode, and switched by a compensation scan signal,
wherein the third transistor includes:
an oxide semiconductor layer including a source area, a drain area, and a channel area disposed between the source area and the drain area; and
a gate electrode disposed on the channel area,
wherein an upper surface of each of the source area, the drain area, and the channel area includes a plurality of first protrusions; and
a user interface configured to sense user input via touch or cursor select of an icon presented on the display panel, wherein the processor is caused to execute one or more of the stored application programs upon receipt of the user input.

20. The electronic device of claim 19, wherein the stored application programs include one or more of a camera application, an audiovisual streaming application, or a telephone application.
